(19) United States
(12) Patent Application Publication
(10) Pub. No.: US 2025/0389872 A1
(43) Pub. Date: Dec. 25, 2025

(54) ELECTRONIC DEVICES

(71) Applicants: InnoLux Corporation, Miao-Li County (TW); CARUX TECHNOLOGY PTE. LTD., APERIA (SG)

(72) Inventors: Wei-Tong SHIH, Tainan (Tainan Science Park) (TW); Chi-Lin LIU, Miao-Li County (TW); Cheng-Wei LIU, Tainan (Tainan Science Park) (TW); Wei-Chi SUNG, Tainan (Tainan Science Park) (TW)

(21) Appl. No.: 19/216,816

(22) Filed: May 23, 2025

(30) Foreign Application Priority Data
Jun. 21, 2024 (CN) 202410808528.5

(51) Int. Cl. G02B 5/08

(52) U.S. Cl. CPC G02B 5/085

(57) ABSTRACT

An electronic device is provided. The electronic device includes a laminated substrate. The laminated substrate includes a substrate having a first surface and a second surface opposite the first surface; a first optical adjustment layer disposed on the first surface; a dielectric layer disposed on the first optical adjustment layer; and an ink layer disposed on the second surface. The first optical adjustment layer includes at least one of a metal material, a semiconductor material, semi-transparent ink and a transparent conductive material.

### CROSS-REFERENCE TO RELATED APPLICATIONS

The present disclosure claims priority of China Application No. 202410808528.5, filed on Jun. 21, 2024, which is incorporated by reference herein in its entirety.

### BACKGROUND

### Technical Field

The present disclosure is related to an electronic device, and more particularly it is related to an electronic device including a reflective element.

### Description of the Related Art

With the development of digital technology, electronic devices with display functions have been widely used in various aspects in daily life. For example, they have been widely used in devices such as televisions, notebooks, smartphones, car display devices, medical display devices, etc.

An electronic device may have display function, optical adjustment function, anti-peeping function and other functions at the same time. Although existing electronic devices may accomplish their intended purposes, they are not satisfactory in every aspect.

### SUMMARY

Some embodiments of the present disclosure provide an electronic device. The electronic device includes a laminated substrate. The laminated substrate includes a substrate having a first surface and a second surface opposite the first surface; a first optical adjustment layer disposed on the first surface; a dielectric layer disposed on the first optical adjustment layer; and an ink layer disposed on the second surface. The first optical adjustment layer includes at least one of a metal material, a semiconductor material, semi-transparent ink and a transparent conductive material.

### BRIEF DESCRIPTION OF THE DRAWINGS

Embodiments of the present disclosure can be best understood from the following detailed description in conjunction with the accompanying drawings. It should be noted that, in accordance with the common practice in the industry, various features are not drawn to scale. In fact, the dimensions of the various elements may be arbitrarily increased or reduced to clearly illustrate the features of the embodiments of the present disclosure. It should also be noted that the drawings illustrate typical embodiments of the present disclosure. The drawings should not be considered as limitation of the present disclosure. The present disclosure may also be applied to other embodiments.

FIG. 1 illustrates a schematic cross-sectional view of a laminated substrate, according to some embodiments of the present disclosure.

FIG. 2 illustrates a schematic diagram of light reflected by a laminated substrate, according to some embodiments of the present disclosure.

FIG. 3 illustrates a schematic cross-sectional view of a laminated substrate, according to some embodiments of the present disclosure.

FIG. 4 illustrates a schematic cross-sectional view of a laminated substrate, according to some embodiments of the present disclosure.

FIG. 5 illustrates a schematic cross-sectional view of a laminated substrate, according to some embodiments of the present disclosure.

FIG. 6 illustrates a schematic diagram of light reflected by a laminated substrate, according to some embodiments of the present disclosure.

FIG. 7 illustrates a schematic cross-sectional view of a laminated substrate, according to some embodiments of the present disclosure.

FIG. 8 illustrates a schematic cross-sectional view of a laminated substrate, according to some embodiments of the present disclosure.

### DETAILED DESCRIPTION

The following disclosure provides many different embodiments, or examples, for implementing different features of the described subject matter. Specific examples of elements and arrangements are described below to simplify the present description. These are, of course, merely examples and are not intended to be limiting. For example, a formation of a first feature over or on a second feature in the description that follows may include embodiments in which the first and second features are formed in direct contact, and may also include embodiments in which additional features may be formed between the first and second features, such that the first and second features may not be in direct contact. Furthermore, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

When an element or layer is “on” or “connected to” another element or layer, it can be directly on or directly connected to another element or layer, or there is an inserted element or layer between the two (indirect case). In contrast, when an element is “directly on” or “directly connected to” another element or layer, there is no intervening element or layer presented.

It should be understood that the ordinal numbers used in the present disclosure, such as the terms “first”, “second”, “third”, etc., are used to modify an element, which itself does not mean and represent that the element (or elements) has any previous ordinal number, and does not mean the order of a certain element and another element, or the order in the manufacturing method. The use of these ordinal numbers is to make an element with a certain name can be clearly distinguished from another element with the same name. The claims and the specification may not use the same terms. For example, the first element in the specification may refer to the second element in the claims.

In the following descriptions, terms “about” and “substantially” typically mean+/−10% of the stated value, or typically +/−5% of the stated value, or typically +/−3% of the stated value, or typically +/−2% of the stated value, or typically +/−1% of the stated value or typically +/−0.5% of the stated value. The values given in the present disclosure are approximate. That is, without specifying the terms “about” and “substantially”, the meaning of “about” and “substantially” can still be implied.

Some embodiments of the present disclosure are described below. Additional steps or operations may be provided before, during, and/or after the steps or operations described in these embodiments. Some of the steps or operations described may be replaced or deleted in different embodiments. In addition, it should be understood that in the following embodiments, without departing from the spirit of the present disclosure, the features in several different embodiments can be replaced, recombined, and mixed to complete another embodiment. The features between the various embodiments can be mixed and matched arbitrarily as long as they do not violate or conflict the spirit of the present disclosure.

In accordance with the embodiments of the present disclosure, the electronic device may include a power module, a semiconductor packaging device, a display device, a backlight device, an antenna device, a touch device, a sensing device, a wearable device, a vehicle device, a battery device, or a tiled device, but it is not limited thereto. The electronic device may be a bendable or flexible electronic device. The display device may be a non-self-luminous display device or a self-luminous display device. The antenna device may be a liquid-crystal type antenna device or a non-liquid-crystal type antenna device. The sensing device may be a sensing device that senses capacitance, light, heat energy or ultrasonic waves, but it is not limited thereto. Furthermore, the electronic device may include, for example, liquid crystals, quantum dots (QDs), fluorescence, phosphorescence, another suitable material, or a combination thereof. The electronic device may include electronic components. The electronic components may include passive components and active components, such as capacitors, resistors, inductors, diodes, transistors, integrated circuits, etc. The diode may include a light-emitting diode or a photodiode. The light-emitting diode may include, for example, an organic light-emitting diode (OLED), a mini light-emitting diode (mini LED), a micro light-emitting diode (micro LED) or a quantum dot light-emitting diode (quantum LED), but it is not limited thereto. In accordance with some embodiments, the electronic device may include a panel and/or a backlight module. The panel may include, for example, a liquid-crystal panel or another self-luminous panel, but it is not limited thereto. The tiled device may be, for example, a display tiled device or an antenna tiled device, but it is not limited thereto. The electronic device may include peripheral systems such as drive systems, control systems, and light source systems to support display devices, antenna devices, wearable devices (for example, augmented reality or virtual reality), vehicle-mounted devices (for example, windshields) or tiled devices. It should be understood that the electronic device can be any permutation and combination of the above, but it is not limited thereto.

In accordance with the embodiments of the present disclosure, a scanning electron microscope (SEM), an optical microscope (OM), a film thickness profiler (α-step), an ellipsometer or another suitable method may be used to measure the width, thickness or height of each element, or spacing or distance between elements. Specifically, in accordance with some embodiments, a scanning electron microscope may be used to obtain a cross-sectional image including the elements to be measured, and the width, thickness or height of each element, or spacing or distance between elements in the image can be measured.

Referring to FIG. 1, an electronic device is provided according to some embodiments of the present disclosure. The electronic device includes a laminated substrate 100. In some embodiments, the laminated substrate 100 includes a substrate 110 having a first surface S1 and a second surface S2. The second surface S2 is opposite to the first surface S1. The laminated substrate 100 further includes a first optical adjustment layer 140 disposed on the first surface S1; a dielectric layer 130 disposed on the first optical adjustment layer 140; and an ink layer 120 disposed on the second surface S2. In addition, the laminated substrate 100 further includes an anti-smudge layer 150 disposed on the dielectric layer 130.

In some embodiments, the substrate 110 may include glass, quartz, ceramic, steel plate, other suitable materials, or a combination thereof, but the present disclosure is not limited thereto. In some embodiments, the ink layer 120 may include a light-shielding material, such as black matrix (BM), black printing ink, black resin, other suitable materials, or a combination thereof, but the present disclosure is not limited thereto. In some embodiments, the anti-smudge layer 150 may enable the laminated substrate 100 to have functions such as waterproof, anti-fingerprint, anti-smudge, anti-fog, and anti-scratch.

In some embodiments, the first optical adjustment layer 140 may include at least one of a metal material, a semiconductor material, a semi-transparent ink and a transparent conductive material. In some embodiments, the metal material may include aluminum (Al), titanium (Ti), tantalum (Ta), niobium (Nb), silver (Ag), chromium (Cr), tellurium (Te), copper (Cu), iron (Fe), nickel (Ni), gold (Au), lead (Pb), other suitable materials, or a combination thereof, but the present disclosure is not limited thereto. In some embodiments, the refractive index of the metal material is approximately 0.1 to 5.0, and the dielectric constant of the metal material is approximately 0.0 to 5.0. The thickness of the metal material is approximately 5 nm to 500 nm, such as 10 nm to 50 nm. In some embodiments, the semiconductor material may include silicon (Si), germanium (Ge), arsenic (As), other suitable materials, or a combination thereof, but the present disclosure is not limited thereto. In some embodiments, the refractive index of the semiconductor material is approximately 1.0 to 5.0, and the dielectric constant of the semiconductor material is approximately 0.0 to 5.0. The thickness of the semiconductor material is approximately 5 nm to 500 nm. In some embodiments, the transparent conductive material may include a transparent conductive oxide (TCO), such as indium tin oxide (ITO), antimony zinc oxide (AZO), tin oxide (SnO), zinc oxide (ZnO), indium zinc oxide (IZO), indium gallium zinc oxide (IGZO), indium tin zinc oxide (ITZO), antimony tin oxide (ATO), other suitable materials, or a combination thereof, but the present disclosure is not limited thereto. In some embodiments, the refractive index of the transparent conductive material is approximately 1.0 to 4.0, and the dielectric constant of the transparent conductive material is approximately 0.0 to 4.0. The thickness of the transparent conductive material is approximately 5 nm to 500 nm.

In some embodiments, the dielectric layer 130 may include bismuth oxide (Bi₂O₃), cerium oxide (CeO₂), chromium oxide (Cr₂O₃), gadolinium oxide (Gd₂O₃), hafnium oxide (HfO₂), lanthanum oxide (La₂O₃), magnesium oxide (MgO), neodymium oxide (Nd₂O₃), titanium oxide (TiO₂), zinc oxide (ZnO), niobium oxide (Nb₂O₅), titanium oxide (Ti₃O₅), tantalum oxide (Ta₂O₅), silicon oxide (SiO₂), aluminum oxide (Al₂O₃), magnesium fluoride (MgF₂), silicon nitride (SiNₓ), titanium nitride (TiN), aluminum oxynitride (A₁OₓN_{y}), lead oxide (PbO), other suitable materials, or a combination thereof, but the present disclosure is not limited thereto. In some embodiments, the refractive index of the dielectric layer 130 is approximately 1.2 to 5.0, and the dielectric constant of the dielectric layer 130 is approximately 0.0 to 2.0. The thickness of the dielectric layer 130 is approximately 5 nm to 500 nm, such as 10 nm to 150 nm. In some embodiments, the first optical adjustment layer 140 is a metal material, and the ratio of the thickness of the first optical adjustment layer 140 to the thickness of the dielectric layer 130 is between 1:1 and 1:100.

When image formation is reflected at an angle, the optical reflectivity in different polarization directions needs to be considered, otherwise the display quality will be affected. According to some embodiments, the present disclosure adjusts the reflectivity of different polarized lights by alternately stacking optical adjustment layers and dielectric layers to achieve the effect of polarized light splitting, thereby improving display quality.

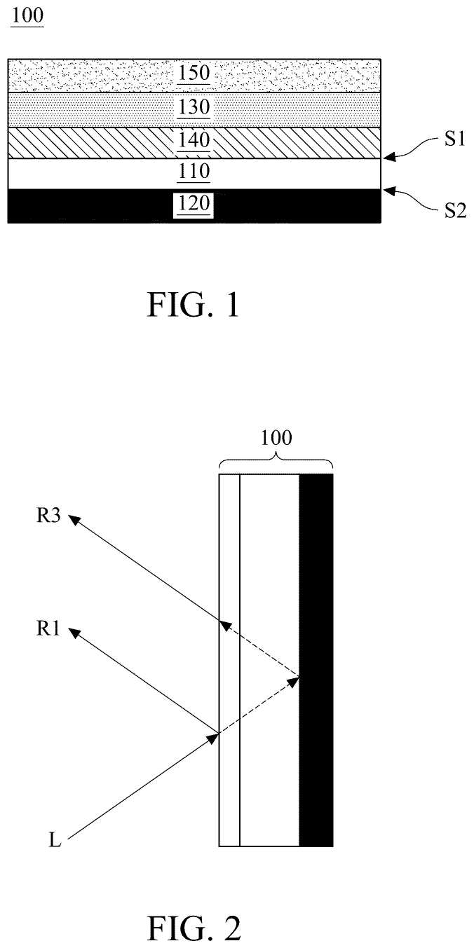

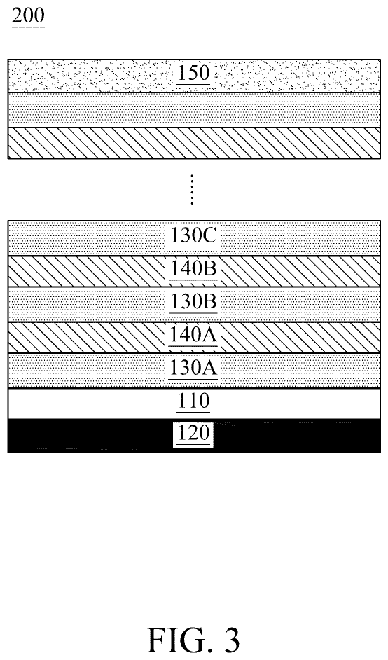

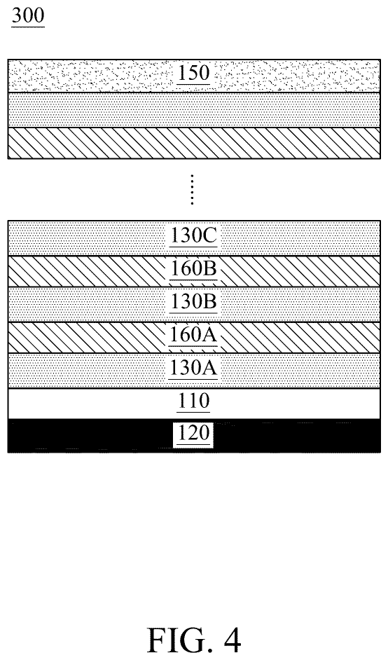

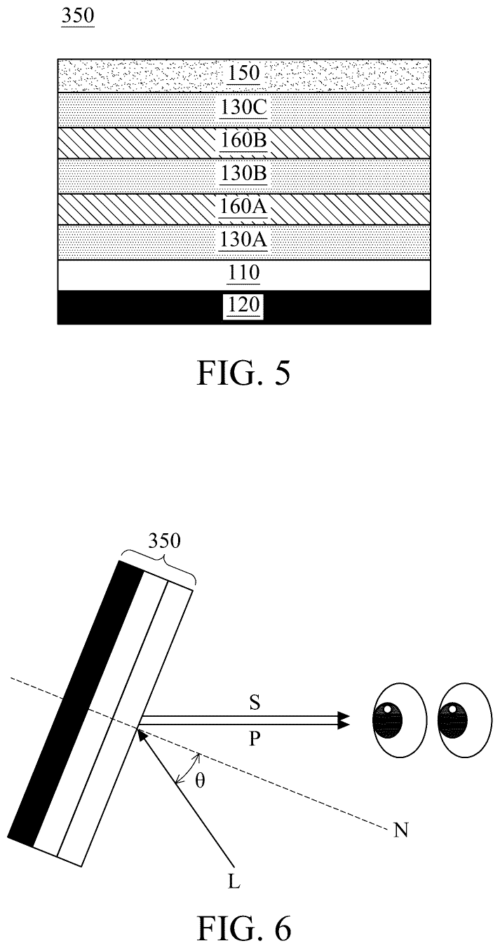

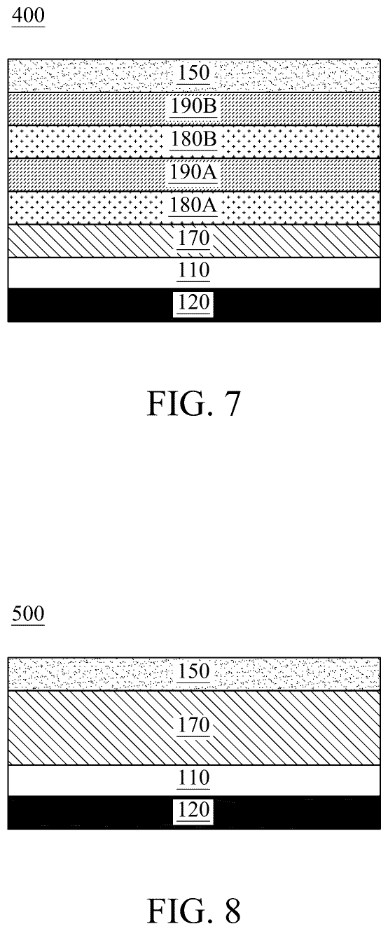

Referring to FIG. 2, FIG. 2 is a schematic diagram showing light L reflected by the laminated substrate 100. As shown in FIGS. 1 and 2, the light L enters the laminated substrate 100 from the side adjacent to the first surface S1. The reflectivity of the light L at the top surface of the top layer (e.g., the anti-smudge layer 150) of the laminated substrate 100 is the first reflectivity R1. The reflectivity of the light L at the interface between the substrate 110 and the bottom layer (e.g., the ink layer 120) of the laminated substrate 100 is the second reflectivity R3. In some embodiments, the ratio (R1/R3) of the first reflectivity R1 to the second reflectivity R3 is greater than 100, which can improve the problem of image overlap, thereby enhancing display quality. It should be understood that FIG. 2 takes the laminated substrate 100 as an embodiment to illustrate the first reflectivity R1 and the second reflectivity R3. The laminated substrate 100 may be replaced by the laminated substrate 200 (as shown in FIG. 3), the laminated substrate 300 (as shown in FIG. 4), the laminated substrate 350 (as shown in FIG. 5), the laminated substrate 400 (as shown in FIG. 7), or the laminated substrate 500 (as shown in FIG. 8). The definitions of the first reflectivity R1 and the second reflectivity R3 remain unchanged.

Referring to FIG. 3, FIG. 3 illustrates a schematic cross-sectional view of a laminated substrate 200, according to some embodiments of the present disclosure. Compared with the laminated substrate 100 shown in FIG. 1, the laminated substrate 200 is different in that it includes a plurality of dielectric layers and a plurality of optical adjustment layers.

In particular, the first dielectric layer 130A is disposed on the substrate 110, the first optical adjustment layer 140A is disposed on the first dielectric layer 130A, the second dielectric layer 130B is disposed on the first optical adjustment layer 140A, the second optical adjustment layer 140B is disposed on the second dielectric layer 130B, and so on. In other words, the dielectric layers and optical adjustment layers are alternately stacked on the substrate. It should be understood that although FIG. 3 shows three dielectric layers 130A, 130B, and 130C and two optical adjustment layers 140A and 140B, the number of dielectric layers and optical adjustment layers is not limited thereto. For example, the stack of dielectric layers and optical adjustment layers may be between 4 and 20 layers. Compared with the conventional and high-cost multi-layer (e.g., more than 20 layers) dielectric layer structure, dual brightness enhancement film (DBEF), or microstructure with specific surface direction, some embodiments of the present disclosure use a smaller number of dielectric layers and optical adjustment layers, which can reduce the cost while improving optical reflectivity and achieving polarized light splitting, thereby improving display quality.

In the embodiment shown in FIG. 3, the first dielectric layer 130A, the second dielectric layer 130B and the third dielectric layer 130C may include bismuth oxide (Bi₂O₃), cerium oxide (CeO₂), chromium oxide (Cr₂O₃), gadolinium oxide (Gd₂O₃), hafnium oxide (HfO₂), lanthanum oxide (La₂O₃), magnesium oxide (MgO), neodymium oxide (Nd₂O₃), titanium oxide (TiO₂), zinc oxide (ZnO), niobium oxide (Nb₂O₅), titanium oxide (Ti₃O₅), tantalum oxide (Ta₂O₅), silicon oxide (SiO₂), aluminum oxide (Al₂O₃), magnesium fluoride (MgF₂), silicon nitride (SiNₓ), titanium nitride (TiN), aluminum oxynitride (AlOₓN_{y}), lead oxide (PbO), other suitable materials, or a combination thereof, but the present disclosure is not limited thereto. In some embodiments, the dielectric layer can tune optical properties, for example, tune the reflectance spectrum. In the embodiment shown in FIG. 3, the first optical adjustment layer 140A and the second optical adjustment layer 140B may include a metal material, such as aluminum (Al), titanium (Ti), tantalum (Ta), niobium (Nb), silver (Ag), chromium (Cr), tellurium (Te), copper (Cu), iron (Fe), nickel (Ni), gold (Au), lead (Pb), other suitable materials, or a combination thereof, but the present disclosure is not limited thereto. In some embodiments, the metal material can increase reflectivity and reduce transmittance.

In some embodiments, the thickness of the first optical adjustment layer 140A and the second optical adjustment layer 140B, which are formed from the metal material, is about 5 nm to 500 nm, such as 10 nm to 50 nm, respectively. The thickness of the first dielectric layer 130A, the second dielectric layer 130B, and the third dielectric layer 130C is about 5 nm to 500 nm, such as 10 nm to 150 nm, respectively. In some embodiments, the ratio of the thickness of the optical adjustment layers 140A, 140B to the thickness of the dielectric layers 130A, 130B, 130C is between 1:1 and 1:100. It should be noted that the thickness ratio mentioned above is the thickness ratio of the minimum thickness of the optical adjustment layer to the minimum thickness of the dielectric layer. In particular, when the first optical adjustment layer 140A and the second optical adjustment layer 140B have the same thickness, and the first dielectric layer 130A, the second dielectric layer 130B, and the third dielectric layer 130C have the same thickness, the thickness ratio is the ratio of the thickness of any one of the first optical adjustment layer 140A and the second optical adjustment layer 140B to the thickness of any one of the first dielectric layer 130A, the second dielectric layer 130B, and the third dielectric layer 130C. When the first optical adjustment layer 140A and the second optical adjustment layer 140B have different thicknesses, or the first dielectric layer 130A, the second dielectric layer 130B, and the third dielectric layer 130C have different thicknesses, the thickness ratio is the ratio of the minimum thickness of the optical adjustment layer to the minimum thickness of the dielectric layer.

In some embodiments, the reflectivity of the light L at the top surface of the top layer (e.g., the anti-smudge layer 150) of the laminated substrate 200 is the first reflectivity R1. The reflectivity of the light L at the interface between the substrate 110 and the bottom layer (e.g., the ink layer 120) of the laminated substrate 100 is the second reflectivity R3. The ratio (R1/R3) of the first reflectivity R1 to the second reflectivity R3 is greater than 100, which can improve the problem of image overlap, thereby enhancing display quality.

Referring to FIG. 4, FIG. 4 illustrates a schematic cross-sectional view of a laminated substrate 300, according to some embodiments of the present disclosure. Compared with the laminated substrate 200 shown in FIG. 3, the laminated substrate 300 is different in that the first optical adjustment layer 160A and the second optical adjustment layer 160B may include materials other than metal materials.

In some embodiments, the first optical adjustment layer 160A and the second optical adjustment layer 160B may include at least one of a metal material, a semiconductor material, a semi-transparent ink, and a transparent conductive material. In some embodiments, the metal material may include aluminum (Al), titanium (Ti), tantalum (Ta), niobium (Nb), silver (Ag), chromium (Cr), tellurium (Te), copper (Cu), iron (Fe), nickel (Ni), gold (Au), lead (Pb), other suitable materials, or a combination thereof, but the present disclosure is not limited thereto. In some embodiments, the semiconductor material may include silicon (Si), germanium (Ge), arsenic (As), other suitable materials, or a combination thereof, but the present disclosure is not limited thereto. In some embodiments, the transparent conductive material may include a transparent conductive oxide (TCO), such as indium tin oxide (ITO), antimony zinc oxide (AZO), tin oxide (SnO), zinc oxide (ZnO), indium zinc oxide (IZO), indium gallium zinc oxide (IGZO), indium tin zinc oxide (ITZO), antimony tin oxide (ATO), other suitable materials, or a combination thereof, but the present disclosure is not limited thereto. In some embodiments, semiconductor materials and transparent conductive materials can adjust coating stress, reduce the probability of peeling, improve polarized light splitting, and enhance scratch resistance.

In some embodiments, the materials of the first optical adjustment layer 160A and the second optical adjustment layer 160B may be the same. In some other embodiments, the materials of the first optical adjustment layer 160A and the second optical adjustment layer 160B may be different. The materials of the first dielectric layer 130A, the second dielectric layer 130B and the third dielectric layer 130C may refer to the embodiment described in FIG. 3. It is not repeated herein. It should be understood that although FIG. 4 shows three dielectric layers 130A, 130B, and 130C and two optical adjustment layers 160A and 160B, the number of dielectric layers and optical adjustment layers is not limited thereto. For example, the stack of dielectric layers and optical adjustment layers may be between 4 and 20 layers. Some embodiments of the present disclosure can improve the optical reflectivity and the polarized light splitting by alternately stacking the optical adjustment layers and the dielectric layers, thereby improving the display quality.

In some embodiments, the thickness of the first optical adjustment layer 160A and the second optical adjustment layer 160B is about 5 nm to 500 nm, such as 10 nm to 50 nm, respectively. The thicknesses of the first dielectric layer 130A, the second dielectric layer 130B, and the third dielectric layer 130C is about 5 nm to 500 nm, such as 10 nm to 150 nm, respectively. In some embodiments, the ratio of the thickness of the optical adjustment layers 160A, 160B to the thickness of the dielectric layers 130A, 130B, 130C is between 1:1 and 1:100.

In some embodiments, the reflectivity of the light L at the top surface of the top layer (e.g., the anti-smudge layer 150) of the laminated substrate 300 is the first reflectivity R1. The reflectivity of the light L at the interface between the substrate 110 and the bottom layer (e.g., the ink layer 120) of the laminated substrate 100 is the second reflectivity R3. The ratio (R1/R3) of the first reflectivity R1 to the second reflectivity R3 is greater than 100, which can improve the problem of image overlap, thereby enhancing display quality.

Referring to FIG. 5, FIG. 5 illustrates a schematic cross-sectional view of a laminated substrate 350, according to some embodiments of the present disclosure. In the embodiment shown in FIG. 5, the substrate 110 is a glass substrate; the ink layer 120 is a black ink; the first dielectric layer 130A includes silicon oxide (SiO₂), aluminum oxide (Al₂O₃), niobium oxide (Nb₂O₅) or a combination thereof; the first optical adjustment layer 160A includes a semiconductor material, such as silicon (Si), germanium (Ge), arsenic (As) or a combination thereof; the second dielectric layer 130B includes silicon oxide (SiO₂), aluminum oxide (Al₂O₃), niobium oxide (Nb₂O₅) or a combination thereof; the second optical adjustment layer 160B includes a metal material, such as niobium (Nb), titanium (Ti), aluminum (Al), copper (Cu), or a combination thereof; and the third dielectric layer 130C includes silicon oxide (SiO₂), aluminum oxide (Al₂O₃), niobium oxide (Nb₂O₅) or a combination thereof.

Referring to FIG. 6, FIG. 6 is a schematic diagram showing the reflection of light L from the laminated substrate 350 shown in FIG. 5. The light L enters the laminated substrate 350 at an angle θ, and is reflected as polarized light P and polarized light S to human eyes. The angle θ may be the angle between the light L and the normal line N of the substrate 110. It can be seen from the following Table 1 that when the incident angle θ is between 10 degrees and 70 degrees, the reflectivity of the polarized light P reflected by the laminated substrate 350 is greater than that of the polarized light S. That is, the embodiments of the present disclosure can control the reflectivity of different polarization directions by alternately stacking the optical adjustment layers and the dielectric layers to achieve the effect of polarized light splitting, thereby improving the display quality.

TABLE 1

| Incident angle θ | Reflectivity of | Reflectivity of |
|---|---|---|
| (degrees) | polarized light P (%) | polarized light S (%) |
| 10 | 19.3 | 19.1 |
| 15 | 19.4 | 18.9 |
| 20 | 19.6 | 18.6 |
| 25 | 19.8 | 18.2 |
| 30 | 20.3 | 17.8 |
| 35 | 21.0 | 17.2 |
| 40 | 22.0 | 16.6 |
| 45 | 23.5 | 16.1 |
| 50 | 25.5 | 15.6 |
| 55 | 28.1 | 15.4 |
| 60 | 31.7 | 15.8 |
| 65 | 36.4 | 17.1 |
| 70 | 42.9 | 20.3 |

In some embodiments, the incident light L is 100%, the first reflectivity R1 of the light L at the top surface of the anti-smudge layer 150 of the laminated substrate 350 is 20%, and the second reflectivity R3 of the light L at the interface between the substrate 110 and the ink layer 120 is 0.03%. The ratio (R1/R3) of the first reflectivity R1 to the second reflectivity R3 is greater than 100, which can improve the problem of image overlap, thereby improving display quality. In some embodiments, the light L transmittance of the ink layer 120 may be approximately 0% to 90%, which can improve display quality.

Referring to FIG. 7, FIG. 7 illustrates a schematic cross-sectional view of a laminated substrate 400, according to some embodiments of the present disclosure. The laminated substrate 400 includes the substrate 110 and the ink layer 120. The materials of the substrate 110 and the ink layer 120 may refer to the embodiment described in FIG. 1. It is not repeated herein. In some embodiments, the ink layer 120 can improve the problem of image overlap, thereby enhancing display quality. The laminated substrate 400 further includes an optical adjustment layer 170; a first dielectric layer 180A disposed on the optical adjustment layer 170; a second dielectric layer 190A disposed on the first dielectric layer 180A; a third dielectric layer 180B disposed on the second dielectric layer 190; a fourth dielectric layer 190B disposed on the third dielectric layer 180B; and an anti-smudge layer 150 disposed on the fourth dielectric layer 190B.

In some embodiments, the optical adjustment layer 170 may include at least one of a metal material, a semiconductor material, a transparent conductive material, and a semi-transparent ink. For example, the optical adjustment layer 170 may include aluminum (Al), titanium (Ti), tantalum (Ta), niobium (Nb), silver (Ag), chromium (Cr), tellurium (Te), copper (Cu), iron (Fe), nickel (Ni), gold (Au), lead (Pb), other suitable materials, or a combination thereof, but the present disclosure is not limited thereto. It should be noted that, although the optical adjustment layer 170 is shown as being disposed between the substrate 110 and the first dielectric layer 180A in FIG. 7, the optical adjustment layer 170 may be disposed at any layer between the substrate 110 and the anti-smudge layer 150.

In some embodiments, the refractive index of the first dielectric layer 180A and the third dielectric layer 180B is greater than the refractive index of the second dielectric layer 190A and the fourth dielectric layer 190B. In some embodiments, the first dielectric layer 180A and the third dielectric layer 180B may include materials with high refractive indexes, such as niobium oxide (Nb₂O₅), titanium oxide (Ti₃O₅), tantalum oxide (Ta₂O₅), other suitable materials, or a combination thereof, but the present disclosure is not limited thereto. The refractive index of the first dielectric layer 180A and the third dielectric layer 180B may be approximately 1.7 to 3.0, respectively. In some embodiments, the second dielectric layer 190A and the fourth dielectric layer 190B may include materials with a low refractive indexes, such as silicon oxide (SiO₂), aluminum oxide (Al₂O₃), magnesium fluoride (MgF₂), other suitable materials, or a combination thereof, but the present disclosure is not limited thereto. The refractive index of the second dielectric layer 190A and the fourth dielectric layer 190B may be approximately 1.3 to 1.7, respectively. Some embodiments of the present disclosure can improve the reflectivity by alternately stacking dielectric layers with high refractive indexes and dielectric layers with low refractive indexes.

Referring to FIG. 8, FIG. 8 illustrates a schematic cross-sectional view of a laminated substrate 500, according to some embodiments of the present disclosure. Compared with the laminated substrate 400 shown in FIG. 7, the laminated substrate 500 is different in that it does not include a dielectric layer. The laminated substrate 500 is a stacked structure without a dielectric layer, but the optical adjustment layer 170 still has the effect of improving the reflectivity and can also reduce the thickness of the laminated substrate 500.

To sum up, some embodiments of the present disclosure provide some benefits. For example, the reflectivity of light of different polarizations can be adjusted by alternately stacking optical adjustment layers and dielectric layers to improve the reflectivity and achieve the effect of polarized light splitting, thereby improving display quality. In addition, the ratio of the reflectivity of light at the top surface of the top layer of the laminated substrate to the reflectivity of light at the interface between the substrate and the bottom layer of the laminated substrate is greater than 100, which can improve the problem of image overlap, thereby enhancing display quality.

Although some embodiments of the present disclosure and their advantages have been described in detail, it should be understood that various changes, substitutions and alterations can be made herein without departing from the spirit and scope of the present disclosure as defined by the appended claims. The features of the various embodiments can be used in any combination as long as they do not depart from the spirit and scope of the present disclosure. Moreover, the scope of the present disclosure is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Thus, the appended claims are intended to include within their scope such processes, machines, manufacture, compositions of matter, means, methods or steps. Moreover, each claim constitutes an individual embodiment, and the claimed scope of the present disclosure includes the combinations of the claims and embodiments. The scope of protection of the present disclosure is subject to the definition of the scope of the appended claims. Any embodiment or claim of the present disclosure does not need to meet all the purposes, advantages, and features disclosed in the present disclosure.

What is claimed is:

1. An electronic device, comprising:
a laminated substrate, comprising:
a substrate having a first surface and a second surface opposite the first surface;
a first optical adjustment layer disposed on the first surface;
a dielectric layer disposed on the first optical adjustment layer; and
an ink layer disposed on the second surface,
wherein the first optical adjustment layer comprises at least one of a metal material, a semiconductor material, a semi-transparent ink and a transparent conductive material.

2. The electronic device of claim 1, wherein the first optical adjustment layer is the metal material.

3. The electronic device of claim 2, wherein the first optical adjustment layer comprises aluminum (Al), titanium (Ti), tantalum (Ta), niobium (Nb), silver (Ag), chromium (Cr), tellurium (Te), copper (Cu), iron (Fe), nickel (Ni), gold (Au), lead (Pb), or a combination thereof.

4. The electronic device of claim 2, wherein a refractive index of the first optical adjustment layer is about 0.1 to 5.0.

5. The electronic device of claim 2, wherein a dielectric constant of the first optical adjustment layer is about 0.0 to 5.0.

6. The electronic device of claim 2, wherein a thickness of the first optical adjustment layer is about 5 nm to 500 nm.

7. The electronic device of claim 1, wherein the first optical adjustment layer is the transparent conductive material.

8. The electronic device of claim 7, wherein a refractive index of the first optical adjustment layer is about 1.0 to 4.0.

9. The electronic device of claim 7, wherein a dielectric constant of the first optical adjustment layer is about 0.0 to 4.0.

10. The electronic device of claim 7, wherein a thickness of the first optical adjustment layer is about 5 nm to 500 nm.

11. The electronic device of claim 1, further comprising a second optical adjustment layer disposed on the dielectric layer.

12. The electronic device of claim 11, wherein the first optical adjustment layer is the semiconductor material, and the second optical adjustment layer is the metal material.

13. The electronic device of claim 12, wherein a ratio of a thickness of the second optical adjustment layer to a thickness of the dielectric layer is between 1:1 and 1:100.

14. The electronic device of claim 12, wherein the first optical adjustment layer comprises silicon (Si), germanium (Ge), arsenic (As), or a combination thereof, and the second optical adjustment layer comprises niobium (Nb), titanium (Ti), aluminum (Al), copper (Cu), or a combination thereof.

15. The electronic device of claim 12, wherein a refractive index of the first optical adjustment layer is about 1.0 to 5.0.

16. The electronic device of claim 12, wherein a dielectric constant of the first optical adjustment layer is about 0.0 to 5.0.

17. The electronic device of claim 1, further comprising an anti-smudge layer disposed on the dielectric layer, wherein a reflectivity of light at a top surface of the anti-smudge layer is a first reflectivity, a reflectivity of light at an interface between the substrate and the ink layer is a second reflectivity, and a ratio of the first reflectivity to the second reflectivity is greater than 100.

18. The electronic device of claim 1, wherein light enters the laminated substrate from a side adjacent to the first surface.

19. The electronic device of claim 1, further comprising a second dielectric layer disposed on the dielectric layer, wherein a refractive index of the dielectric layer is greater than a refractive index of the second dielectric layer.

20. The electronic device of claim 1, wherein a transmittance of the ink layer is 0% to 90%.
